(19) United States
(12) Patent Application Publication
(10) Pub. No.: US 2016/0065736 A1
(43) Pub. Date: Mar. 3, 2016

(54) AUTOMATED INCIDENT MANAGEMENT INTERROGATION ENGINE

(71) Applicant: Verizon Patent and Licensing Inc., Arlington, VA (US)

(72) Inventors: Evan Pedersen, Colorado Springs, CO (US); Belinda A. Franklin-Barr, Colorado Springs, CO (US); Tad E. Smith, Colorado Springs, CO (US)

(21) Appl. No.: 14/471,598

(22) Filed: Aug. 28, 2014

(51) Int. Cl. H04M 3/51; G06Q 30/00

(52) U.S. Cl. CPC H04M 3/51; G06Q 30/016

(57) ABSTRACT

Methods, devices, and non-transitory storage media to receive ticket information of a ticket that indicates a problem in providing a service to a customer; receive event information that indicates an action performed by at least one of a device or a person to resolve the ticket; select a filter, among multiple filters, to filter the event information based on the action indicated in the event information; select a criteria rule, from among multiple criteria rules, based on filtered event information and parameters included in the criteria rule, wherein each criteria rule includes parameters and values for each parameter; select an output result rule, from among multiple output result rules, that maps to the criteria rule; generate a message that provides an update to a status of the ticket based on the filtered event information and the output result rule; and transmit the message to the customer.

### BACKGROUND

Call centers provide various services to customers, such as technical support, change of service, sign on new customers, terminate service, initiate repairs, etc. The network allows call center representatives (also known as call center agents) to interact with customers or potential customers through various forms of communication, such as telephone, e-mail, etc.

### BRIEF DESCRIPTION OF THE DRAWINGS

FIG. 1 is a diagram illustrating an exemplary environment in which an exemplary embodiment of an Enterprise Trouble Management System (ETMS) may be implemented;

FIG. 2A is a diagram illustrating exemplary functional components of the ETMS device depicted in FIG. 1;

FIGS. 2B-2D diagrams illustrating an exemplary process performed by the ETMS device;

FIG. 2E is a diagram illustrating another exemplary process of the ETMS device;

FIGS. 3A and 3B are diagrams illustrating exemplary user interfaces pertaining to the ETMS device;

FIG. 4 is a diagram illustrating exemplary components of a device that may correspond to one or more of the devices in the exemplary environment;

FIGS. 5A and 5B are flow diagrams illustrating an exemplary process for generating a message to a customer based on event information; and

FIG. 5C is a flow diagram illustrating an exemplary process for generating a message.

### DETAILED DESCRIPTION OF PREFERRED EMBODIMENTS

The following detailed description refers to the accompanying drawings. The same reference numbers in different drawings may identify the same or similar elements. Also, the following description does not limit the invention.

A representative of a call center may use various tools to provide customer service support. For example, the representative may use a computer, a telephone (e.g., soft or hard), and various service software for call handling, account management, etc. Typically, the representative handles particular calls from customers within the call center. In a repair call center, the representative handles calls from customers that request assistance with a problem with service. In some cases, the representative may be able to resolve the customer's issue. In other cases, the representative may conclude that a repair, a service call, or further investigation is warranted. Based on such a determination, the representative may issue a ticket that pertains to the customer's call and/or problem. According to other scenarios, the customer may create a ticket via an automated system when the issue cannot be resolved. According to still other scenarios, a service provider system may automatically detect a service issue and generate a ticket in response to detecting the service issue.

Unfortunately, after the ticket is generated and the service provider assigns resources (e.g., personnel, device-based troubleshooting measures, etc.) to resolve the issue, the customer may subsequently call the repair call center or an automated system to obtain information regarding the issue. These circumstances can frustrate the customer. Additionally, from the service provider's perspective, the additional calls result in additional costs and usage of resources to handle the customer's further inquiries.

According to an exemplary embodiment, an Enterprise Trouble Management System (ETMS) includes an Automated Incident Management Interpretation Engine (AIMIE) that monitors events following an issuance of a ticket. An “event,” as used herein, refers to an activity involving a human, a device, or both, that pertains to resolving the issue and/or closing the ticket. As an example, a technician may submit a notice to a network device that provides details regarding repairs or assessments. The AIMIE will obtain information included in the notice. As another example, a network device may test or diagnose customer premises equipment. The AIMIE will obtain information pertaining to the outcome of the test or diagnose. Further examples of events are described below

According to an exemplary embodiment, upon receipt of event information, the AIMIE identifies whether the event information contains information that a customer would want to know about. For example, according to an exemplary embodiment, the AIMIE may use business rules and/or policies that indicate which events the AIMIE is to consider as an update for the customer. Based on a determination that an event includes information useful to the customer (e.g., in terms of status), according to an exemplary embodiment, the AIMIE selects and translates, if needed, the event information or a portion for use in generating a customer update. The AIMIE may use other information (e.g., metadata) to generate the customer update. For example, the AIMIE may identify whether the ticket was customer-initiated or proactively generated, whether the ticket was generated via a repair center or via a web site, etc.

According to an exemplary embodiment, the AIMIE automatically generates customer updates based on the translated event information. The AIMIE transmits or makes available the customer updates to customers. For example, the AIMIE may transmit a customer update to the customer via an e-mail, a Short Messaging Service (SMS) message, a Multimedia Messaging Service (MMS) message, or an automated telephone call. Additionally, or alternatively, the AIMIE may make available the customer update to the customer via a web portal, a web site, a mobile application, or some other type of communicative medium.

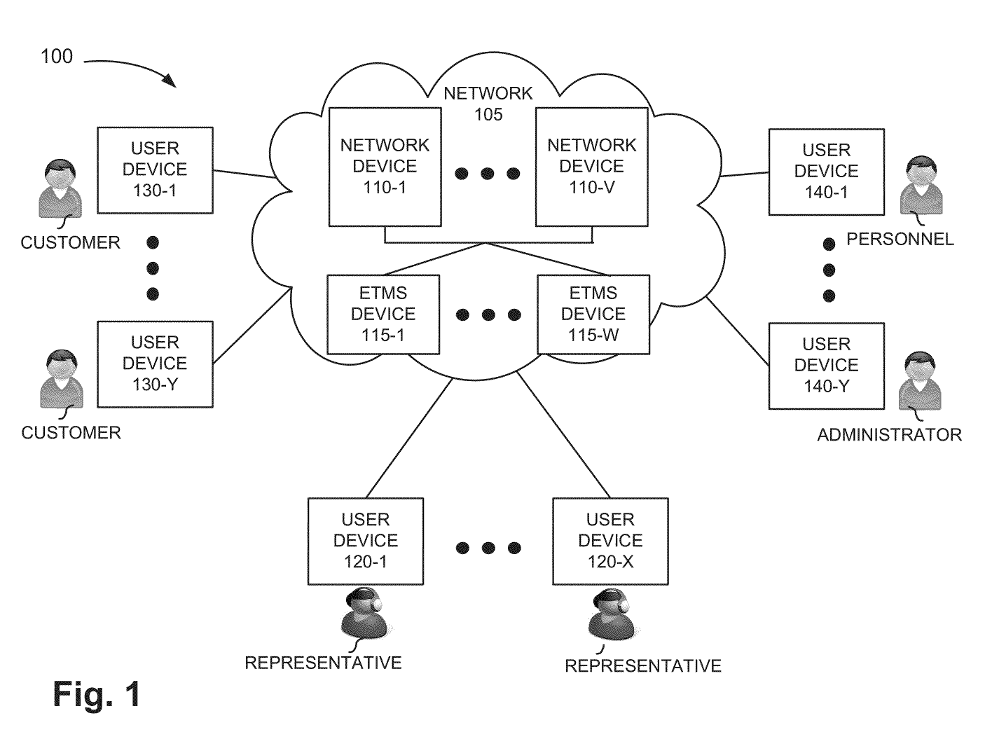

FIG. 1 is a diagram illustrating an exemplary environment 100 in which an exemplary embodiment of an Enterprise Trouble Management System (ETMS) may be implemented. As illustrated, environment 100 includes a network 105 that includes network devices 110-1 through 110-V, in which V>1 (also referred to collectively as network devices 110 or generally as network device 110) and ETMS devices 115-1 through 115-W, in which W>1 (also referred to collectively as ETMS devices 115 or generally as ETMS device 115). Environment 100 also includes user devices 120-1 through 120-X, in which X>1 (also referred to collectively as user devices 120 or generally as user device 120) and user devices 130-1 through 130-Y, in which Y>1 (also referred to collectively as user devices 130 or generally as user device 130).

Environment 100 may be implemented to include wired, optical, and/or wireless connections among the devices and network illustrated. A connection may be direct or indirect and may involve intermediary device(s) and/or network(s) not illustrated in FIG. 1. Additionally, the number and the arrangement of connections between the devices and the network are exemplary.

The number of devices and networks, and the configuration in environment 100 are exemplary. According to other embodiments, environment 100 may include additional devices, fewer devices, different devices, and/or differently arranged devices, than those illustrated in FIG. 1. Additionally, or alternatively, environment 100 may include an additional network and/or a differently arranged network, than that illustrated in FIG. 1.

A device may be implemented according to a centralized computing architecture, a distributed computing architecture, or a cloud computing architecture. Additionally, a device may be implemented according to one or multiple network architectures (e.g., a client device, a server device, a peer device, a proxy device, or a combination thereof).

Network 105 includes one or multiple networks of one or multiple types. For example, network 105 may include a public network, a private network, a wide area network, the Internet, a metropolitan area network, a data network, a packet-based network, a circuit-based network, a telephone network (e.g., Voice-over Internet Protocol (VoIP) network, a public switched telephone network (PSTN)), or some combination thereof.

Network devices 110 include network devices that provide call center services. For example, a portion of network devices 110 may include an automatic call distribution (ACD) device, an interactive voice response (IVR) device, a computer telephony integration (CTI) device, a customer relationship management (CRM) device, a call data device, a storage device that stores a customer database, or some combination of these devices. Network devices 110 may also include a web-based customer service device. For example, the web-based customer service device includes service software that allows representatives to sign-up new customers, pull account information pertaining to existing customers, order new services, order equipment, disconnect a service, cancel a service, and generate a ticket, etc., regarding a service offered by a service provider. By way of example, the service may include a telephone service, Internet service, mobile service, and/or television service.

Network devices 110 include network devices that monitor a network that provides the service. For example, a portion of network devices 110 may include network monitoring systems (NMSs) that identify specific activities and performance metrics to determine various events, such as outages, overloaded and/or crashed devices in the network, link failures, etc. The NMSs may also provide alarms and other types of information pertaining to the state of the network. The NMSs may initiate tests to diagnose network issues, generate reports based on the results of tests, etc. Network devices 110 include network devices that gather information from various parties, such as repair personnel, technicians, an e-bonded local exchange carrier (LEC), a third party, etc.

Network devices 110 also include network devices that are used by ETMS devices 115 to output event information to customers. For example, a portion of network devices 110 may include communication servers (e.g., e-mail server, MMS server, SMS server, voice server, an on-line portal, etc.) to push messages (e.g., text, e-mail, automated voice, message postings, etc.) to customers, and an e-bonding device (business-to-business (b2b) web service) for customers.

ETMS device 115 includes a network device that processes ticket information and event information to generate messages to customers. According to an exemplary embodiment, ETMS device 115 receives ticket information pertaining to a ticket. For example, the ticket may have been generated based on a customer inquiry or complaint, or proactively generated directly from a device (e.g., NMS, etc.). According to an exemplary embodiment, ETMS device 115 receives event information from network devices 110. For example, ETMS device may receive event information from a call center device, an NMS device, a user device associated with a party (e.g., a repair person, etc.), and a communication server (e.g., an online portal, an e-mail server, etc.), such as a message posted for or sent to the customer. As described further below, ticket information and event information include information that is not understandable by a customer. For example, the ticket information and event information may include various codes or other forms of strings (e.g., abbreviations, nomenclatures, etc.).

According to an exemplary embodiment, ETMS device 115 filters ticket information and event information. According to an exemplary embodiment, the filters are defined using a Structured Query Language (SQL)-like syntax that converts ticket information and event information into a format that can be processed by the AIMIE. According to an exemplary embodiment, the AIMIE receives filtered information and processes the filtered information based on business process modeling and notation (BPMN) definitions, domain-specific service tasks, and rule tables, as described further below. According to an exemplary embodiment, ETMS device 115 includes a user interface layer that allows an administrator to view, configure, and modify, the operation of ETMS device 115, as described further below. According to an exemplary embodiment, ETMS device 115 outputs to a communication server to allow customers to be informed about the status of the ticket.

User device 120 includes a device having communicative and display capabilities. For example, user device 120 may include a computer (e.g., a desktop computer, a laptop computer, etc.). User device 120 may include a softphone. Alternatively, user device 120 may include a hardphone. User device 120 also includes a web browser to communicate with network device 110 (e.g., a customer service software server, etc.). Representatives of the service provider operate user devices 120 to interact with customers and other parties, as well as devices in network 105. User devices 130 and user devices 140 may include various types of end user devices, such as mobile devices, portable devices, stationary devices, etc., to communicate with various parties and devices of network 105. By way of further example, user devices 130 and/or user devices 140 may take the form of a computer (e.g., a desktop computer, a laptop computer, a palmtop computer, a tablet computer, a netbook, etc.), a personal digital assistant (PDA), a personal communication system (PCS) terminal, a smartphone, a Web/Internet access device or other type of network access device. As illustrated, customers operate user devices 130 and various individuals (e.g., service provider personnel (e.g., repair personnel, etc.), network administrator, a third party, etc.) operate user devices 140.

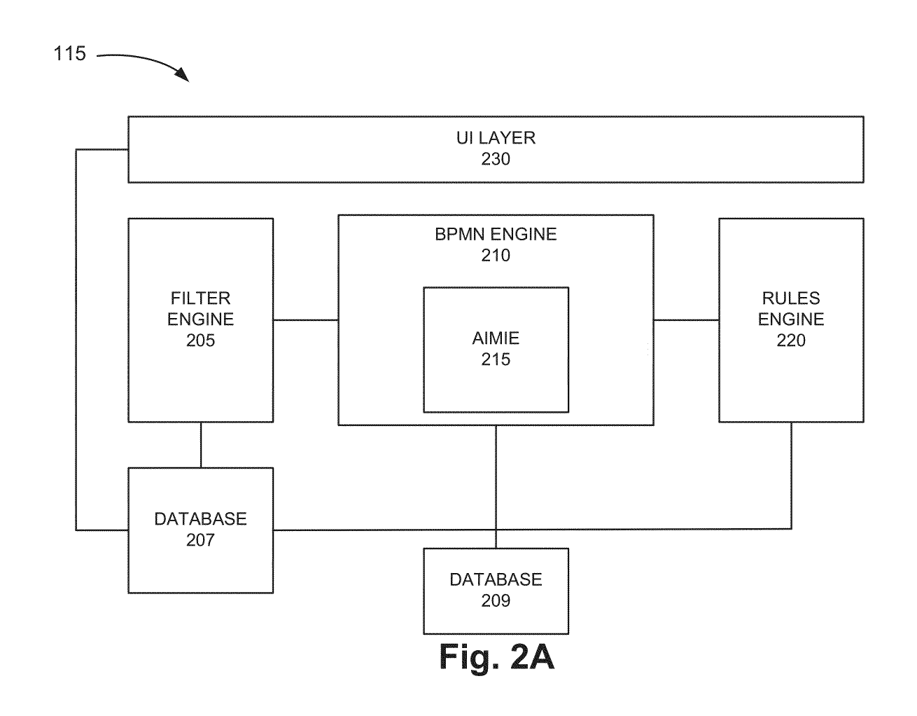

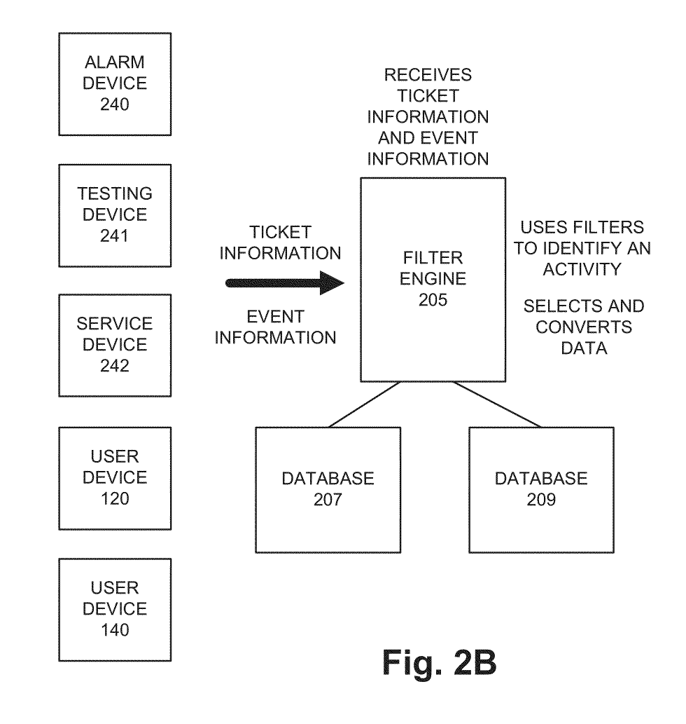

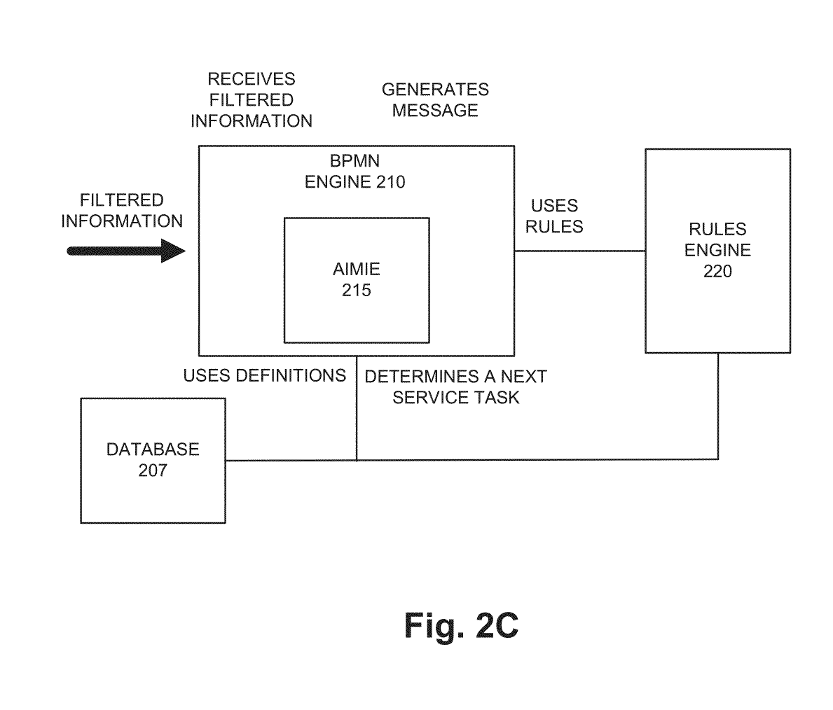

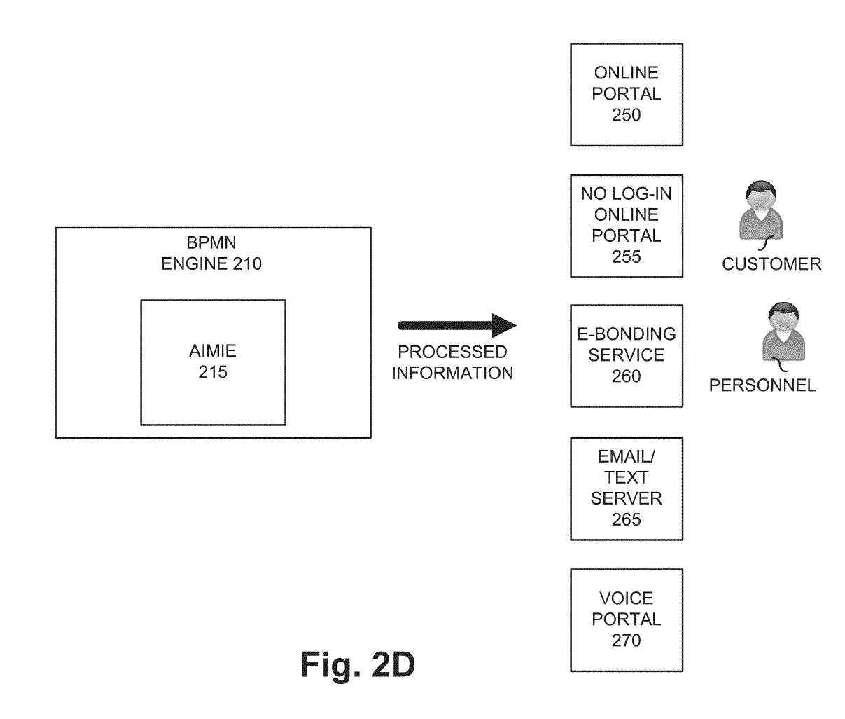

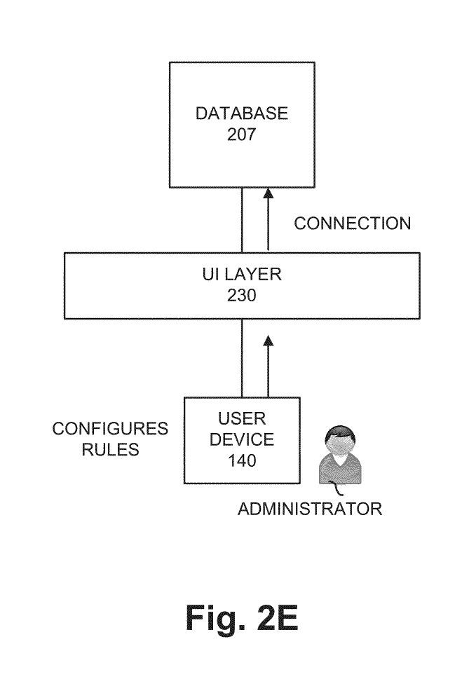

FIG. 2A is a diagram illustrating exemplary functional components of ETMS device 115. As illustrated, ETMS device 115 includes a filter engine 205, a database 207, a database 209, a business process modeling and notation (BPMN) engine 210 that includes an Automated Incident Management Interpretation Engine (AIMIE) 215, a rules engine 220, and a user interface (UI) layer 230.

According to an exemplary embodiment, filter engine 205 receives ticket information and/or event information from network devices 110, user devices 120, user devices 130, and user devices 140. For example, when a customer contacts a representative because of a service issue, the representative creates a ticket via user device 120 and network device 110 (e.g., a customer service device). The ticket information may include, for example, a date and a timestamp pertaining to the creation of the ticket, the name of the customer, the location of the customer, a description of issue or problem, an identifier of the representative, and other information (e.g., codes or other types of stringed data). Additionally, as previously described, subsequent to the issuance of the ticket, various activities may be performed involving a human, a device, or both, that pertains to resolving the issue and/or closing the ticket, which in turn results in the generation of event information.

According to an exemplary embodiment, filter engine 205 includes logic that analyzes the ticket information and the event information. According to an exemplary embodiment, filter engine 205 includes filters that identify an “activity” pertaining to the event information. By way of example, an activity may be to dispatch a technician, refer to a third party, add test data, etc. An exemplary list of activities and description are provided below.

| Activity | Description |
|---|---|
| Comments | General comment on ticket progress |
| Modify | Update a ticket attribute value |
| Ticket Notify | Send an email about the current status of the ticket |
| Assign User | Give responsibility for the next task or tasks to a specific person |
| Dispatch Status | Log the status of the field dispatch in the ticket log |
| Update Customer | Log the general status, in a customer readable way, in the ticket log |
| Create | Open a ticket on a specific incident |
| Cross Reference | Relate this ticket to another ticket |
| Unassign | Relieve responsibility for the ticket from a specific person |
| Release | Return ticket to a mode where impact time continues to increment |
| Resolve | Indicate the impact is no longer occurring. |
| Close | Ticket is complete and no further action is necessary |
| Update Resolve | Modify the actual outage time based on known impact factors |
| Start | Indicate work has begun |
| Acknowledge | Indicate receipt of the input |
| Monitor Service | Watch and confirm service is working |
| Stop | Indicate work has stopped |
| Refer Out | Request assistance from another work team |
| Transfer Ownership | Give responsibility of ticket to another work team |
| Add Attachment | Add an electronic file as an attached element of the ticket |
| Refer Back | Indicate assistance is no longer required |
| Create Customer Request | Create a task to fulfil a request from a customer |
| Customer Time | Indicate no further progress can be made until customer responds |
| Maintenance Time | Indicate resolution awaiting a maintenance event |
| Add Test Data | Document diagnostic results in the ticket log |
| App Deny | Approve or Deny a requested activity |
| Pend Esc | Escalation is pending internal approval |
| Assign Request | Accept responsibility for fulfilling a customer request |
| Start Monitor | Indicate monitor period has begun |
| Suspend | Suspend automatic escalations |
| Stop Monitor | Indicate monitor period has stopped |
| Esc Manual | Adhoc ticket escalation based on human decision |
| Customer Request | Customer has made a request for or has provided information |
| Reopen | Indicate the issue remains and additional work is required |
| EB Fix pending | Electronic Bonding partner requires confirmation fix worked |
| Update Invoice | Update an invoice |
| EB Fix Verify | Electronic Bonding. We confirm the fix worked. |
| EB get | Electronic Bonding - retrieve current status from partner/vendor |
| Await Invoice | Status indication - pending invoice |
| Ext Customer Time | Customer is unable to respond |
| Esc Notify | Notify responsible team via email that customer has escalated |
| Complete | Fulfilment of customer request is complete |
| EB Fix Deny | Electronic Bonding - problem still exists |
| Change Prim NEID | Replace service identifier with correct value |
| Void | Ticket is not valid |
| Esc Automatic | Automated proactive escalation |
| Schedule RFC | Change Request - Schedule a Request For Change |
| Add Line Record | Indicate other services are impacted |
| EB Cancel Request | Electronic Bonding - indicate problem cleared. |
| EB Force Close | Electronic Bonding - Close ticket without response from vendor |
| Unassign Request | Relinquish responsibility for fulfilling a customer request |
| Page Technician | Page a technician |
| Add Task | Add a task |
| Alternate Route | Indicate customer is working on an alternate network path |
| Update Task | Update task record |
| Schedule Maintenance | Schedule a maintenance appointment of a device |
| Delete Attachment | Remove attachment file from ticket |

According to an exemplary embodiment, filter engine 205 identifies an activity based on data included in the event information. For example, the event information includes an activity code and/or other types of data such as data indicating who performed an activity (e.g., an acting group, a name of a person), data indicating what was said about the activity, etc. The event information may include data that is not understandable by a person (e.g., a customer, service provider personnel, etc.). According to an exemplary embodiment, based on an identification of the activity, filter engine 205 selects and converts data included in the event information to be used by BPMN engine 210 and AIMIE 215. According to an exemplary embodiment, filter engine 205 selects and converts data that allows AIMIE 215 to select a rule for generating a message that is understandable by a person (e.g., the customer, etc.).

Database 207 stores data that is used by other functional components to perform the processes described herein. For example, database 207 stores filters. The filters identify certain data instances or criteria in the ticket information and event information. Based on such identification, the filters determine what type of processing, if any, is to be performed by BPMN engine 210 and AIMIE 215. According to an exemplary implementation, the filters are written in Structured Query Language (SQL). However, other suitable programming languages may be used.

Database 207 stores definitions. BPMN engine 210 uses the definitions to control the execution flow of activities used to close or resolve a ticket. For example, the definitions specify which activity is to be performed based on an analysis of the ticket information and/or event information received, generate command requests to have next activities performed, transmit the command requests to other devices (e.g., network devices 110, user devices 140, etc.), store ticket information and event information in database 209, etc.

Database 207 stores various types of rules. For example, the rules include functional rules that specify an operation to be performed on a given instance of data. The rules also include criteria rules. For example, the criteria rules specify values, which can be used, based on a comparison to the event information being processed, to determine a selection of one of the output result rules. The output result rules indicate values and/or text to be used to generate the message to the customer. The rules also include default output result rules. For example, the default output result rules indicate default values and/or text for output when there is no match with a criteria rule. That is, the information being processed does not satisfy any of the criteria rules.

Database 209 stores ticket information, event information, and messages communicated to customers. Databases 207 and/or 209 may be implemented as a relational database or other suitable type of database. Databases 207 and 209 may include a database management system that supports, among other things, a data model and a query language, and controls data access, data integrity, etc., relative to a database or a data structure.

BPMN engine 210 includes logic that controls the workflow of tickets towards resolutions. For example, BPMN engine 210 interprets a status of the ticket and determines what action should be performed based on an analysis of the ticket information and/or the event information. BPMN engine 210 may identify a person, a device, or a combination thereof to perform the action. In turn, BPMN engine 210 may transmit a request or a command to have the action performed and await a result of the action. BPMN engine 210 may determine to have multiple actions performed in parallel. BPMN engine 210 receives event information, which pertains to the outcome of the requested action, from filter engine 205. BPMN engine 210 controls the workflow of the ticket based on the event information.

AIMIE 215 includes logic that generates messages to customers based on information received from rules engine 220. For example, AIMIE 215 uses the information of the selected output rule or a default output rule, as described below, to generate a message to the customer. AIMIE 215 determines the mode of communication of the message (e.g., on-line, e-mail, text, etc.) to be used. AIMIE 215 may also generate a message directed to other persons (e.g., associated with the service provider, a third party, etc.). AIMIE 215 is described further below.

Rules engine 220 includes logic that applies the rules to event information. For example, rule engine 220 applies criteria rules to event information to determine which criteria rule is satisfied. According to an exemplary implementation, rule engine 220 compares a value associated with a particular parameter, as set forth by a criterion rule, to the event information. For example, the criteria rules include an acting group parameter, a product type parameter, a received parameter, a power parameter, text search parameter, a technical management group parameter, a symptom parameter, and a last comment parameter. The acting group parameter indicates a working group of the service provider or a third party for which a translation of event information and generation of a customer message will occur. The product type parameter indicates a product or a service, which is applicable to the ticket, for which translation of event information and generation of a customer message will occur. The received parameter indicates a source (e.g., a person, a device, etc.) from which the ticket was opened. The text search parameter indicates a string that is to be present in the event information. For example, the event information may indicate that “testing could not be completed,” “problem with local exchange carrier,” “local exchange carrier referral final comments,” or other text that indicates an outcome of an activity or, more generally, the status of the ticket. The technical management group parameter identifies a particular technical management group associated with the service provider or a third party. The symptom parameter indicates a reason for opening the ticket. For example, the reason may be represented by a code or string. The last comment parameter indicates a last communication sent to the customer regarding the status of the ticket. This information may be used to avoid duplication of messages sent to the customer, previous status of the ticket, etc.

Rules engine 220 selects an output result rule that maps to a criteria rule when it is determined that all of the parameter values of the criteria rule match the event information. The output result rule indicates a value and/or text that can be used to generate a message to the customer, a message or a comment included in the message that is directed to the service provider or a third party, etc. As an example, the output result rules include a reset parameter, an internal comment parameter, a customer comment parameter, a status update parameter, a modify access parameter, a type of comment parameter, a template parameter, a show parameter, and an access type parameter. The reset parameter indicates whether to remove next action due (NAD) codes from the translation process. The internal comment parameter indicates whether to add a comment to the ticket with no notification. For example, the comment can be an internal communication directed to a person associated with the service provider or a third party or directed to the customer. The customer comment parameter indicates that the update will be viewable on the portal. The update customer parameter indicates the update is meant to be viewable specifically by the customer via every available delivery method.

The type of comment parameter indicates how the comment is displayed on the ticket internally. For example, a comment parameter of “general” indicates that the comment only appears in the activity log. A comment parameter of “status” appears continually on the main page of the ticket for the duration of the ticket and can be overwritten with an additional status comment. The modify access parameter indicates whether to modify the access type of the translated input to prevent showing both versions to the customer. For example, the access to the message may be changed from “customer” to “internal” and avoid having both the old version and the new version available to the customer. The template parameter indicates the exact translation applied for tracking and metrics reporting purposes. The show parameter indicates whether to make the status update of the ticket available to a no log-in on-line portal and/or to make a comment available to the customer or keep the comment internal. The access type parameter indicates whether to make the status update of the ticket visible to the customer or keep the update internal. However, as previously described, if there is no match to a criteria rule, then a default message to the customer may be selected and used.

User interface layer 230 includes logic that allows a user (e.g., an administrator) to configure ETMS device 115. User interface layer 230 provides user interfaces to allow the user to view, create, edit, and delete data stored in database 207, such as the filters, the definitions, and the rules. According to an exemplary implementation, the user accesses user interface layer 230 via a web browser or other suitable client or agent software. A description of processes performed by ETMS device 115 is provided further below.

FIGS. 2B-2D are diagrams illustrating an exemplary enterprise trouble management system process in which a message is generated based on event information. Referring to FIG. 2B, assume that ticket information and event information are received from one or multiple devices, such as an alarm device 240, a testing device 241, a service device 242, a user device 120, or user device 140. Alarm device 240 includes a device that provides network monitoring system (NMS) functions, as previously described with respect to network device 110. Testing device 241 includes a device that initiates tests to diagnose network issues, generates reports, etc., as previously described with respect to network device 110. Service device 242 includes a device that provides a service to the customer, such as a set top box, an interactive voice response (IVR) device, an in-home router, or other type of node that may provides the service, such as a television service, a telephone service, an Internet service, or a mobile service. User device 120 and user device 140 have been previously described. As an example, a representative of the service provider operate user device 120 and may interact with the customer, create a ticket, and/or enter event information. Additionally, various personal may operate user device 140 and provide event information pertaining to a ticket. Ticket information is received by filter engine 205 and stored in database 209. Additionally, messages that are transmitted to the customer and event information may be stored in database 209. In this way, database 209 stores historical information pertaining to the ticketing and resolution process.

As illustrated, filter engine 205 uses filters to identify an activity included in the event information, as previously described. For example, the event information may include an activity code, as well as other information, such as information that identifies what device performed the activity or which working group performed the activity, comments pertaining to the activity, etc. Filter engine 205 selects and filters data included in the event information based on the identified activity. Referring to FIG. 2C, filter engine 205 transmits the filtered data to BPMN engine 210 and AIMIE 215. Upon receiving the filtered data, AIMIE 215 uses the rules engine 220 to apply the criteria rules to the filtered data. As previously described, rules engine 220 applies the criteria rules to determine the output result rule. For example, rules engine 220 compares values associated with parameters, as set forth in the criteria rules, to determine if a match of all of the parameters and their values exist relative to the filtered data. According to this exemplary process, assume that a match exists. Rule engine 220 selects an output result rule that maps to the matched criteria rule. AIMIE 215 generates a message based on the output result rule (e.g., the parameters and values). AIMIE 215 may select a template message based on the output result rule. For example, the template message is a human-readable message that informs the customer of the status of the ticket. AIMIE 215 determines the mode of communication for the message (e.g., on-line, e-mail, text, etc.) to be used. Referring to FIG. 2D, AIMIE 215 transmits the message to one or multiple devices, such as an online portal 250, a no log-in, online portal 255, an e-bonding service 260, an e-mail/text server 265, or a voice portal 270. For example, online portal 250 may include a web site that requires a customer log in, a no log-in, online portal 255 may include a web site that does not require a customer log in, an e-bonding service 260 includes a device that provides an e-bonding service (e.g., a ticket may be referred out to an e-bonded local exchange carrier), e-mail/text server 265 includes a device that provides e-mail and/or text service(s), and voice portal 270 includes a device that provides voice messages. The message is made available to the customer via one or multiple of these devices.

Additionally, referring back to FIG. 2C, BPMN engine 210 uses the definitions to control the execution flow of activities to close or resolve the ticket. Based on an evaluation of the filtered information and the definitions, BMPN engine 210 determines a next service task. For example, BMPN engine 210 may issue a request or a command to a device or a person to perform an action that may lead to the resolution of the issue.

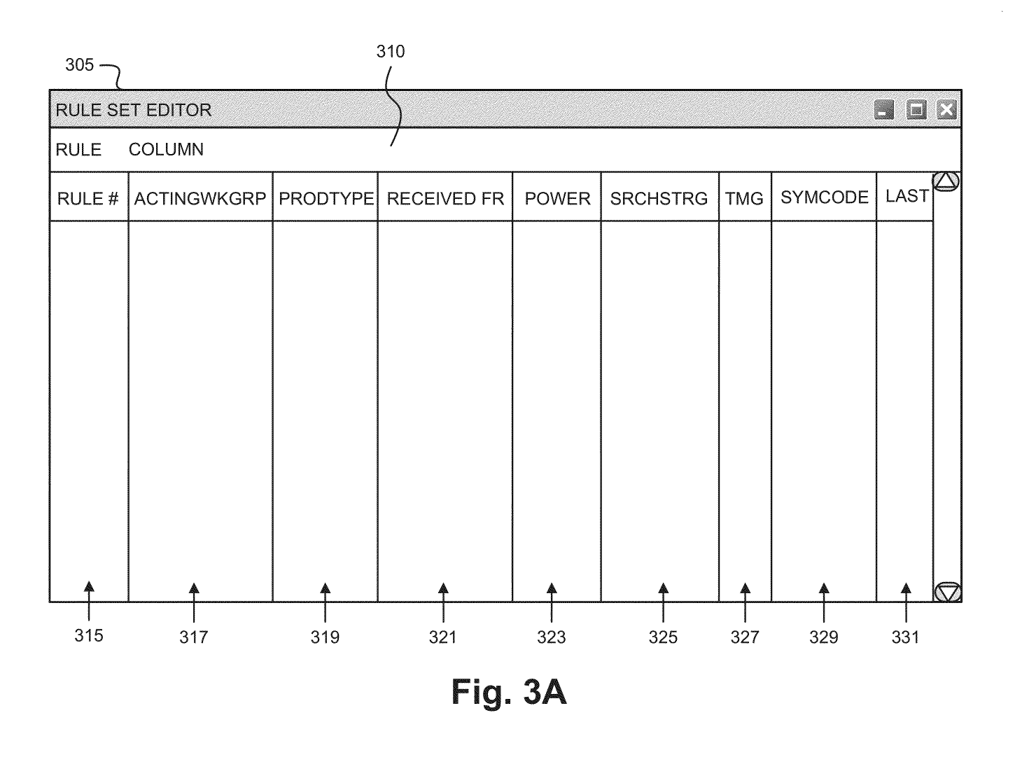

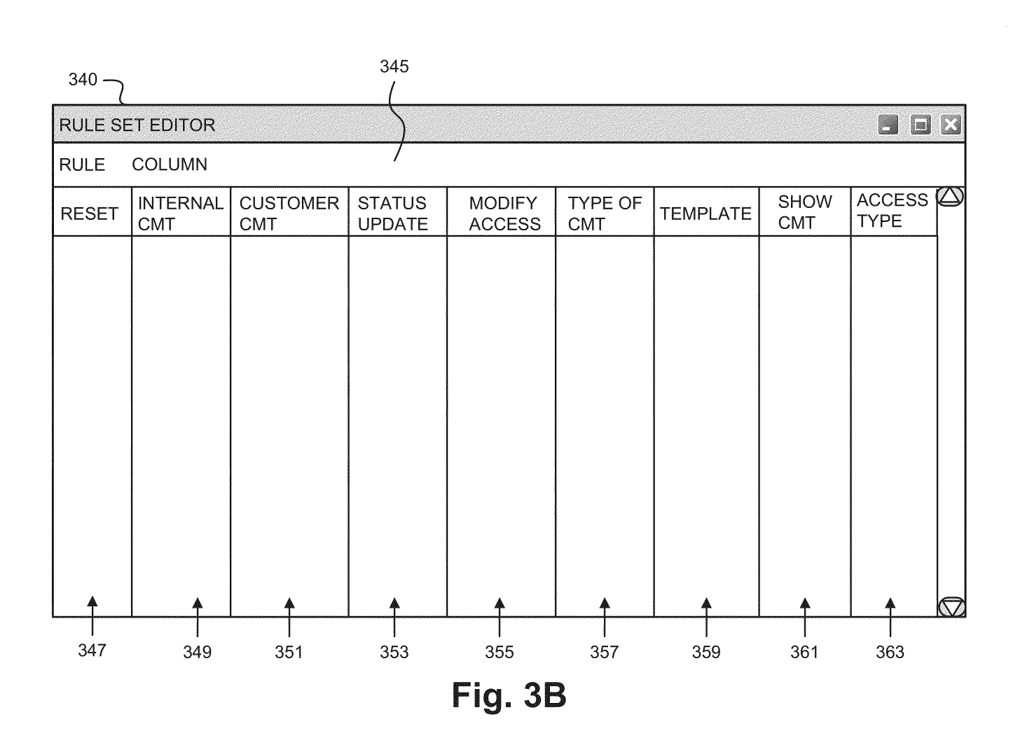

FIG. 2E is a diagram illustrating another exemplary process of the ETMS device 115. For example, assume an administrator establishes a connection with database 207 via UI layer 230. For example, as previously described, user device 140 may include client software that permits access to database 207. Also assume that the administrator wishes to configure the rules stored in database 207 via a user interface. FIGS. 3A and 3B are diagrams illustrating exemplary user interfaces that allow the user to configure the rules. Referring to FIG. 3A, a user interface 305 provides a rule set editor. The rule set editor allows the administrator to configure criteria rules. User interface 305 includes a menu bar 310. Menu bar 310 includes exemplary drop-down menus, such as “rule,” and “column.”

Although not illustrated, “rule” includes a drop-down menu that allows the administrator to add and delete a rule. “Rule” may also allow the administrator to specify the number of parameters for a new rule as well as specify the parameters. Although not illustrated, “column” includes a drop-down that allows the administrator to add, delete, or edit a column and a parameter value for a column. As further illustrated, user interface 305 includes various parameter fields, such as a rule number field 315, an action working group field 317 (illustrated as ACTINGWKGRP), a product type field 319 (illustrated as PRODTYPE), a received from field 321 (illustrated as RECEIVED FR), a power field 323, a search string field 325 (illustrated as SRCHSTRG), a technical management group field 327 (illustrated as TMG), a symptom field (illustrated as SYMCODE), and a last comment field 331 (illustrated as LAST). Rule number field 315 indicates a number or other unique identifier that refers to a particular rule. The remaining parameter fields have been previously described in relation rules engine 220. For example, action working group field 317 indicates a working group of the service provider or a third party for which a translation of event information and generation of a customer message will occur, product type field 319 indicates a product or a service, which is applicable to the ticket, for which translation of event information and generation of a customer message will occur, etc. The administrator may edit, create, or delete parameter values assigned to each parameter field. For example, in the acting working group field 317, the administrator may enter an identifier of a work group (e.g., internal testing working group) associated with the service provider.

Referring to FIG. 3B, also assume that the administrator also wishes to configure output result rules. Referring to FIG. 3B, a user interface 340 provides a rule set editor. The rule set editor allows the administrator to configure output result rules. User interface 345 includes a menu 310. Menu 310 includes exemplary drop-down menus, such as “rule,” and “column.”

Although not illustrated, “rule” includes a drop-down menu that allows the administrator to add and delete a rule. “Rule” may also allow the administrator to specify the number of parameters for a new rule as well as specify the parameters. Although not illustrated, “column” includes a drop-down that allows the administrator to add, delete, or edit a column and a parameter value for a column. As further illustrated, user interface 340 includes various parameter fields, such as a reset field 345, an internal comment field 349 (illustrated as INTERNAL CMT), a customer comment field 351 (illustrated as CUSTOMER CMT), a status update field 353, a modify access field 355, a type of comment field 357 (illustrated as TYPE OF CMT), a template field 359, a show comment field 361 (illustrated as SHOW CMT), and an access type field 363. The parameter fields have been previously described in relation rules engine 220. For example, reset field 345 indicates whether to remove a next action due code from the translation process when a customer message is generated, internal comment field 349 indicates whether to add a comment to the ticket with no notification, etc.

The administrator may edit, create, or delete parameter values assigned to each parameter field. For example, in the show comment field 361, the administrator may enter a parameter value to allow the status update of the ticket available to customer via no log-in online portal 255.

Although FIGS. 3A and 3B illustrate exemplary user interfaces 305 and 340, according to other implementations, user interfaces 305 and/or 340 may includes additional, different, or fewer parameter fields, additional, different, or fewer menus, etc.

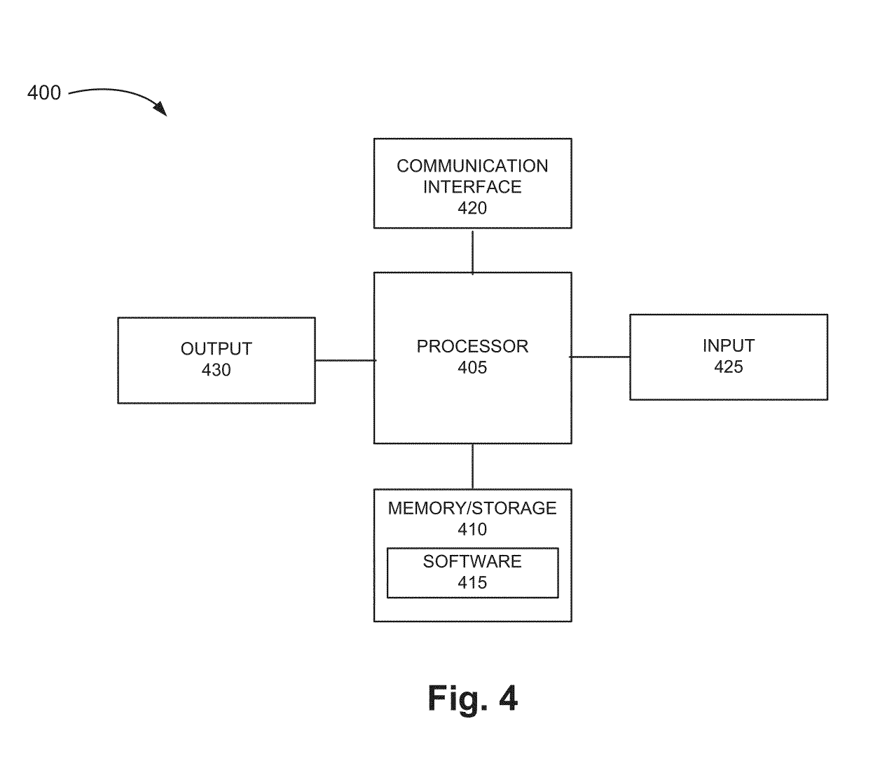

FIG. 4 is a diagram illustrating exemplary components of a device 400 that may correspond to one or more of the devices in environment 100. For example, device 400 may correspond to components included in network devices 110, ETMS devices 115, user device 120, user devices 130, and/or user devices 140. As illustrated, device 400 includes a processor 405, a memory/storage 410 that stores software 415, a communication interface 420, an input 425, and an output 430. According to other implementations, device 400 may include fewer components, additional components, different components, and/or a different arrangement of components than those illustrated in FIG. 4 and described herein.

Processor 405 includes one or multiple processors, microprocessors, data processors, co-processors, multi-core processors, application specific integrated circuits (ASICs), controllers, programmable logic devices, chipsets, field programmable gate arrays (FPGAs), system on chips (SoCs), programmable logic devices (PLSs), microcontrollers, application specific instruction-set processors (ASIPs), central processing units (CPUs), or some other component that interprets and/or executes instructions and/or data. Processor 405 may be implemented as hardware (e.g., a microprocessor, etc.) or a combination of hardware and software (e.g., a SoC, an ASIC, etc.). Processor 405 may include one or multiple memories (e.g., memory/storage 410), etc.

Processor 405 may control the overall operation, or a portion of operation(s) performed by device 400. Processor 405 may perform one or multiple operations based on an operating system and/or various applications or programs (e.g., software 415). Processor 405 may access instructions from memory/storage 410, from other components of device 400, and/or from a source external to device 400 (e.g., another device, a network, etc.).

Memory/storage 410 includes one or multiple memories and/or one or multiple other types of storage mediums. For example, memory/storage 410 may include one or multiple types of memories, such as, random access memory (RAM), dynamic random access memory (DRAM), cache, read only memory (ROM), a programmable read only memory (PROM), a static random access memory (SRAM), a single in-line memory module (SIMM), a dual in-line memory module (DIMM), a flash memory, and/or some other type of memory. Memory/storage 410 may include a hard disk (e.g., a magnetic disk, an optical disk, a magneto-optic disk, a solid state disk, etc.) and a corresponding drive. Memory/storage 410 may include a hard disk (e.g., a magnetic disk, an optical disk, a magneto-optic disk, a solid state disk, etc.), a Micro-Electromechanical System (MEMS)-based storage medium, and/or a nanotechnology-based storage medium. Memory/storage 410 may include drives for reading from and writing to the storage medium.

Memory/storage 410 may be external to and/or removable from device 400, such as, for example, a Universal Serial Bus (USB) memory stick, a dongle, a hard disk, mass storage, off-line storage, or some other type of storage medium (e.g., a compact disk (CD), a digital versatile disk (DVD), a Blu-Ray® disk (BD), etc.). Memory/storage 410 may store data, software, and/or instructions related to the operation of device 400

Software 415 includes an application or a program that provides a function and/or a process. Software 415 may include firmware. For example, with reference to ETMS devices 115, software 415 may include an application that, when executed by processor 405, provides the functions of filter engine 205, BPMN engine 215, AIMIE 215, and rules engine 220, as described herein.

Communication interface 420 permits device 400 to communicate with other devices, networks, systems and/or the like. Communication interface 420 includes one or multiple wireless interface(s) and/or wired interface(s). For example, communication interface 420 may include one or multiple transmitter(s) and receiver(s), or transceiver(s).

Input 425 provides an input into device 400. For example, input 425 may include a keyboard, a keypad, a touchscreen, a touch pad, a touchless screen, a mouse, an input port, a button, a switch, a microphone, a knob, and/or some other type of input.

Output 430 provides an output from device 400. For example, output 430 may include a display, a speaker, a light (e.g., light emitting diode(s), etc.), an output port, a vibratory mechanism, and/or some other type of output.

Device 400 may perform a function or a process in response to processor 405 executing software instructions stored by memory/storage 410. For example, the software instructions may be read into memory/storage 410 from another memory/storage 410 or read from another device via communication interface 420. The software instructions stored in memory/storage 410 may cause processor 405 to perform processes described herein. Alternatively, according to another implementation, device 400 may perform a process or a function based on the execution of hardware (e.g., processor 405, etc.).

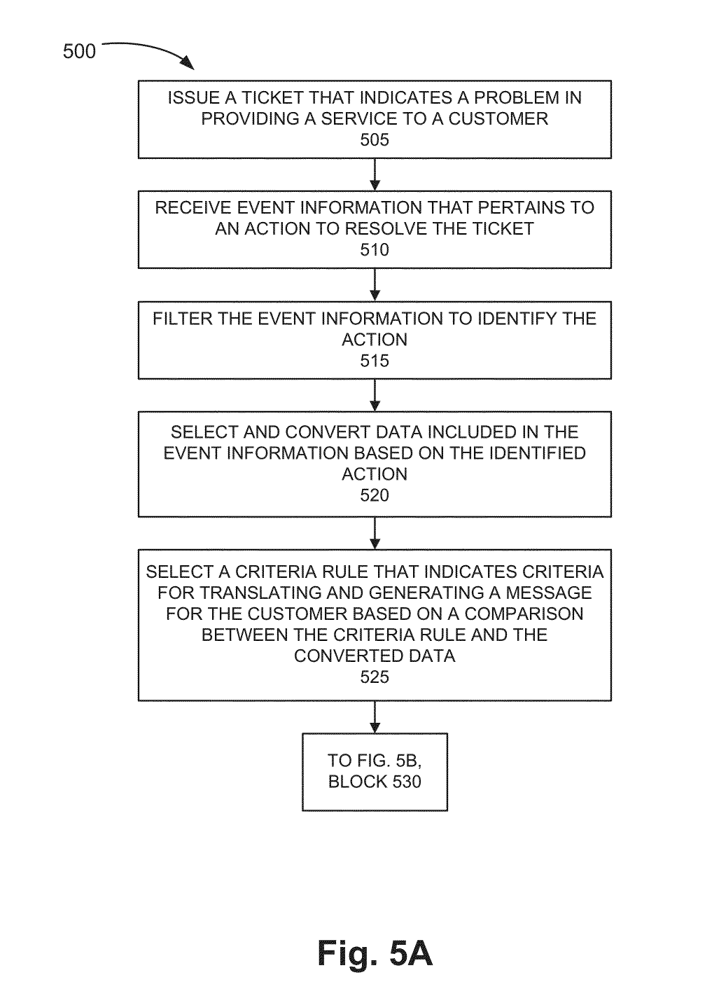

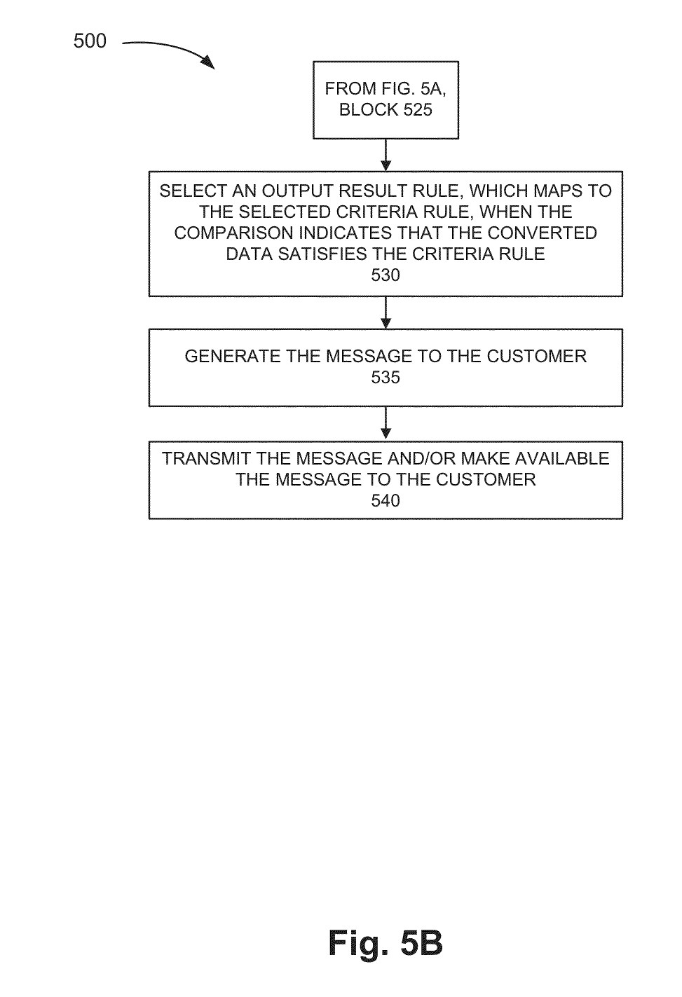

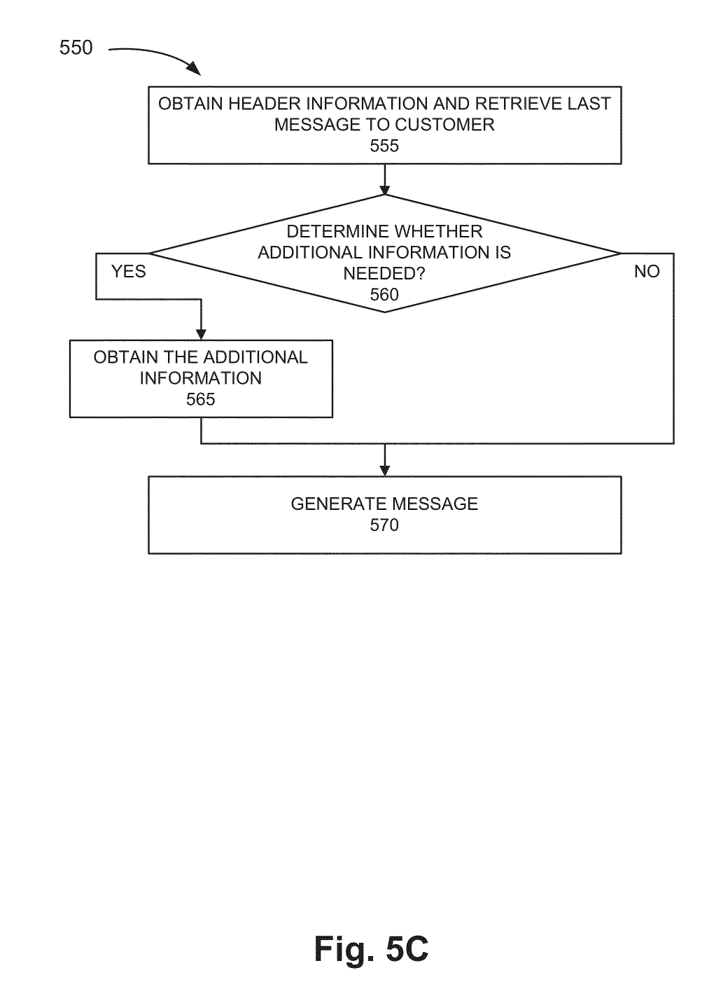

FIGS. 5A and 5B are flow diagrams illustrating an exemplary process 500 for generating a message to a customer based on event information associated with the issuance of ticket that indicates a problem in service. Process 500 is directed to an exemplary embodiment previously described above with respect to FIGS. 2B-2D, as well as elsewhere in this description, in which ETMS device 115 generates a message for a customer based on event information associated with the issuance of a ticket. According to an exemplary embodiment, one or more operations of process 500 are performed by ETMS device 115. For example, the functionality of filter engine 205, BPMN engine 210, AIMIE 215, rules engine 220 may be implemented by processor 405 executing software 415. Databases 207 and 209 may also include network devices that are implemented by processor 405 executing software 415 (e.g., a database management system).

Referring to FIG. 5A, in block 505, a ticket is issued that indicates a problem in providing a service to a customer. For example, a representative of a service provider may receive a telephone call from a customer about a problem with a service (e.g., a telephone service, a television service, an Internet service, a mobile service). The representative creates a ticket. Alternatively, the customer may create a ticket through an automated system, or a service provider system may automatically detect a service issue and create a ticket. The ticket information is stored in database 209 via filter engine 205 or directly. BPMN engine 210 may also receive the ticket information and determine a first action to take in order to resolve the ticket. For example, BPMN engine 210 uses the definitions stored in database 207 to control the execution flow of activities towards resolving the ticket.

In block 510, event information that pertains to an action to resolve the ticket is received. For example, event information may be transmitted from a device, such as alarm device 240, testing device 241, service device 242, user device 120, and/or user device 140. The event information is received by filter engine 205. The event information may be obtained based on an action requested by BPMN engine 210.

In block 515, event information is filtered to identify the action. For example, the event information includes an activity code and/or other types of data such as data indicating who performed an activity (e.g., an acting group, a name of a person), data indicating what was said about the activity, etc. Filter engine 205 identifies the activity pertaining to the event information. For example, filter engine 205 includes filters. According to an exemplary implementation, each filter may be designated to identify one or multiple activities (e.g., activity codes). When the filter determines that the particular activity included in the event information is a match with its configuration, the filter proceeds to process the event information, as described herein.

In block 520, data included in the event information is selected and converted based on the identified action. For example, a filter of filter engine 205 selects data included in the event information, some of which may be converted (e.g., to a particular format), by the filter. Alternatively, filter may not need to convert any data. The filter is configured to select particular data from the event information so that a message may be subsequently generated by AIMIE 210. The filter of filter engine 205 transmits the filtered data to AIMIE 215.

The event information may also be stored in database 209 via filter engine 205 or directly. BPMN engine 210 may use the event information to determine whether a next action to resolve the ticket problem should be carried out and, if so, what action that would be, etc., as previously described.

In block 525, a criteria rule that indicates criteria for translating and generating a message for the customer based on a comparison between the criteria rule and the converted data. For example, AIMIE 215 uses rules engine 220 to select a particular criteria rule. As previously described, rules engine 220 matches the parameters of the criteria rules to the filtered data. In this case, assume that rules engine 220 identifies a match with one of the criteria rules. Rules engine 220 selects the matching criteria rule. According to other implementations, rules engine 220 may use the filtered data and other data to select a particular criteria rule, as described further below in relation to process 550 of FIG. 5C.

Referring to FIG. 5B, in block 530, an output result rule, which maps to the selected criteria rule, is selected when the comparison indicates that the converted data satisfies the criteria rule. For example, as previously described, rules engine 220 selects an output result rule that maps to the selected criteria rule. The output result rule indicates particular parameters and values.

In block 535, the message to the customer is generated. For example, AIMIE 215 uses the selected output result rule to generate the message. A further description of the generation of the message is illustrated in FIG. 5C and provided below.

In block 540, the message is transmitted to or made available to the customer. For example, AIMIE 215 transmits the message to online portal 250, no log-in online portal 255, e-mail/text server 265, and/or voice portal 270. The customer receives the message and is informed of the status of the ticket.

Although FIGS. 5A and 5B illustrate an exemplary process 500, according to other implementations, process 500 may include additional operations, fewer operations, and/or different operations than those illustrated in FIGS. 5A and 5B, and described herein.

FIG. 5C is a flow diagram illustrating an exemplary process 550 for generating a message to a customer. Process 550 is directed to an exemplary embodiment previously described above with respect to FIGS. 2A-2D, as well as elsewhere in this description.

Referring to FIG. 5C, in block 555, header information and a last message to the customer is obtained. For example, AIMIE 215 obtains ticket information from database 209. AIMIE 215 uses the ticket information to generate a header for the message. Additionally, for example, AIMIE 215 obtains a last message sent to the customer (if any exists) from database 209.

In block 560, it is determined whether additional information is needed. For example, AIMIE 215 determines whether local exchange carrier (LEC) information is needed. If so, AIMIE 215 obtains LEC information that may include data that identifies the LEC and any information provided by the LEC (e.g., resolution information from the LEC). Additionally, depending on the activity indicated in the event information, AIMIE 215 obtains contact information pertaining to the customer as well as other information. For example, AIMIE 215 obtains communication information (e.g., telephone number, e-mail address, etc., which may pertain to home, work, etc., any customer preferences regarding modes of communication, etc.) of the customer and obtains product and/or service information pertaining to the customer. AIMIE 215 determines a mode of communication to communicate the message. Additionally, for example, AIMIE 215 may determine whether to obtain a certain type of information that may be used in the message, such as information identifying the location of an outage or estimated time of arrival (ETA) of a service technician. AIMIE 215 may also determine whether the ticket has a parent ticket. For example, if a parent ticket pertains to an outage of a certain locale and the customer is located in that locale, then AIMIE 215 obtains information about the parent ticket. For example, AIMIE 215 obtains the parent ticket number and obtains an activity log pertaining to the resolution process of the parent ticket. AIMIE 215 identifies the last activity pertaining to the parent ticket. AIMIE 215 also determines whether dynamic transaction rules are to be used. For example, a down hard code extracted from a ticket can be translated dynamically by generating a rule translation table and applying customer readable replacement text for that value.

If it is determined that additional information is needed (block 560—YES), then the additional information is obtained (block 565). For example, AIMIE 215 obtains the additional information and proceeds to block 570. If it is determined that additional information is not needed (block 560—NO), then process 550 proceeds to block 570.

In block 570, the message is generated. For example, AIMIE 215 generates the message based on the ticket information, the last message to the customer, the additional information, the filtered data, the criteria rule, and the output result rule. As previously described, AIMIE 215 may use the filtered data and one or more instances of the additional information to select the criteria rule. Alternatively, AIMIE 215 may use the filtered data to select the criteria rule, as previously described. AIMIE 215 may make certain determinations regarding the generation of the message, mode of communication, etc., as previously described. For example, AIMIE 215 may determine that the message is posted on-line but no e-mail is sent to the customer, or that the message is posted on-line and an e-mail is sent to the customer. Additionally, or alternatively, AIMIE 215 may remove the next action due (NAD) code as a part of the translation process and/or change the access mode for the message from “customer” to “internal.”

Although FIG. 5C illustrates an exemplary process 550, according to other implementations, process 550 may include additional operations, fewer operations, and/or different operations than those illustrated in FIG. 5C, and described herein.

In view of the foregoing, devices, methods, and systems may automate the generation of messages so that customers are informed about the status of their service. This may result in a reduction of calls and inquiries from customers.

Information that may otherwise be in non-human readable form may be translated and packaged into messages directed to customers, third parties, and/or personnel of the service provider. As an example, if a ticket is proactively created by alarm device 240, due to an alarm condition, alarm device 240 may insert a variety of comments about the state of the alarm. AIMIE 215 continuously monitors the alarm status, based on messages received from alarm device 240, and generates message updates to a customer, such as “all alarms have cleared,” “alarms re-occurred,” “automated testing has begun,” or “testing determined that the problem is coming from the customer premise equipment (CPE).” According to another example, if a ticket is created and AIMIE 215 does not identify its parent ticket (e.g., an outage), BPMN engine 210 instructs testing device 241 to perform some initial testing. AIMIE 215 monitors messages from the test results, parses the messages and translates the messages into customer friendly verbiage. For example, AIMIE 215 may generate a message that informs the customer that their issue was confirmed and what next step will be taken in the resolution process. AIMIE 215 obtains information regarding how the customer created the ticket (e.g., on-line, via telephone, etc.), if any steps were taken by the customer to resolve the issue (e.g., reboot a device, disconnect and reconnect any wires, etc.). According to yet another example, if a ticket is referred out to an e-bonded LEC, AIMIE 215 monitors the LEC communication for changes in dispatch status, and when an update is received, BPMN engine 210 ensures that the update follows a logical sequence of actions relative to a last update or state of the ticket, and if so, AIMIE 215 updates the customer with the new status of the ticket. As an example, when the e-bonded LEC returns a fix verification notice, AIMIE 215 parses the event information associated with the verification notice and verifies that a trouble-found code matches the technician's description of the problem. If there is a match, AIMIE 215 translates and generates a message to inform the customer about the action taken by the e-bonded LEC. Additionally, the message may indicate that the service provider will independently verify the state of the customer's problem.

AIMIE 215 performs other services. For example, based on event information gathered on a ticket, AIMIE 215 communicates to the customer that the ticket is closed and that the customer will receive a survey for which the customer participation is requested. Additionally, when a ticket is opened, AIMIE 215 determines if customer contact information is stale. If so, AIMIE 215 transmits a message to the customer to update and/or validate his or her contact information in order to avoid delays in resolving the problem. Additionally, if during initial processing of the ticket, BPMN engine 210 determines that the problem is caused by a schedule maintenance event, AIMIE 215 generates a message informing the customer that their service will be verified at the end of the scheduled maintenance. AIMIE 215 may also insert promotional advertisements pertaining to a service or a product in a message to a customer regarding the status of a ticket.

Subsequent to the resolution of their problems, a large percentage of customers reopen their tickets because the customers wish for their service to be monitored. To minimize the cost in processing requests to reopen the tickets, AIMIE 215 generates a message that indicates, even though a ticket is cleared, the service will be monitored for a time, and if an interruption to the service occurs, the ticket will be automatically re-opened.

In the preceding specification, various embodiments have been described with reference to the accompanying drawings. However, various modifications and changes may be made thereto, and additional embodiments may be implemented, without departing from the broader scope of the invention as set forth in the claims that follow. The specification and drawings are accordingly to be regarded as illustrative rather than restrictive.

In the specification and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The embodiments described herein may be implemented in many different forms of software executed by hardware. For example, a process or a function may be implemented as “logic” or as a “component.” The logic or the component may include, for example, hardware (e.g., processor 405, etc.), or a combination of hardware and software (e.g., software 415). The embodiments have been described without reference to the specific software code since software can be designed to implement the embodiments based on the description herein.

Additionally, embodiments described herein may be implemented as a non-transitory storage medium that stores data and/or information, such as instructions, program code, data structures, program modules, an application, etc. The program code, instructions, application, etc., is readable and executable by a processor (e.g., processor 405) of a computational device. A non-transitory storage medium includes one or more of the storage mediums described in relation to memory/storage 410.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items.

In addition, while series of blocks have been described with regard to the processes illustrated in FIGS. 5A-5C, the order of the blocks may be modified in other implementations. Further, non-dependent blocks may be performed in parallel. Additionally, with respect to other processes described in this description, the order of operations may be different according to other implementations, and/or operations may be performed in parallel.

No element, act, operation, or instruction described in the present application should be construed as critical or essential to the embodiments described herein unless explicitly described as such.

What is claimed is:

1. A method, comprising:
generating ticket information of a ticket that indicates a problem in providing a service, by a service provider, to a customer;
receiving, by a device, the ticket information;
receiving, by the device, event information that indicates an action performed by at least one of a device or a person to resolve the ticket;
selecting, by the device, a filter, among multiple filters, to filter the event information based on the action indicated in the event information;
selecting, by the device, a criteria rule, from among multiple criteria rules, based on filtered event information and parameters included in the criteria rule, wherein each criteria rule includes parameters and values for each parameter;
selecting, by the device, an output result rule, from among multiple output result rules, that maps to the criteria rule;
generating, by the device, a message that provides an update to a status of the ticket based on the filtered event information and the output result rule; and
transmitting, by the device, the message to another device that the customer can access.

2. The method of claim 1, further comprising:
comparing the filtered information to the parameters and values of one or more criteria rules; and
determining whether the filtered event information matches the parameters and the values of at least one of the one or more criteria rules, and wherein the selecting the criteria rule comprises:
selecting the criteria rule based on a match between the filtered event information and the parameters and the values of the criteria rule.

3. The method of claim 2, wherein the parameters include a parameter that identifies a particular product or service, a parameter that indicates a particular text string that is to be present in the event information, a parameter that indicates a reason for generating the ticket, and a parameter that indicates a last message sent to the customer regarding the ticket.

4. The method of claim 1, wherein each output result rule includes parameters and values for each parameter, wherein the parameters include a parameter that indicates whether to add a comment to the ticket, wherein the comment is not presented to the customer in the message, and a parameter that indicates whether to change an access to the message from the customer to internal personnel of the service provider.

5. The method of claim 1, further comprising:
analyzing, by the device, the ticket information;
determining, by the device, what action to take to resolve the ticket; and
transmitting, by the device, a request to the at least one of the device or the person to perform the action, based on the determining.

6. The method of claim 1, wherein the service is a television service, a telephone service, or an Internet service.

7. The method of claim 1, further comprising:
obtaining a last message transmitted to the customer;
determining that local exchange carrier information is needed; and wherein the generating comprises
using the last message and the local exchange carrier information to generate the message.

8. The method of claim 1, further comprising:
determining whether the ticket has a parent ticket, wherein the parent ticket pertains to an outage; and
obtaining information pertaining to the parent ticket based on determining that the ticket has the parent ticket.

9. The method of claim 1, wherein each output result rule includes a parameter and a value that indicates a mode of communication for communicating the message to the customer.

10. A device comprising:
a communication interface;
a memory, wherein the memory stores instructions; and
a processor, wherein the processor executes the instructions to:
receive, via the communication interface, ticket information of a ticket that indicates a problem in providing a service, by a service provider, to a customer;
receive, via the communication interface, event information that indicates an action performed by at least one of a device or a person to resolve the ticket;
select a filter, among multiple filters, to filter the event information based on the action indicated in the event information;
select a criteria rule, from among multiple criteria rules, based on filtered event information and parameters included in the criteria rule, wherein each criteria rule includes parameters and values for each parameter;
select an output result rule, from among multiple output result rules, that maps to the criteria rule;
generate a message that provides an update to a status of the ticket based on the filtered event information and the output result rule; and
transmit, via the communication interface, the message to another device that the customer can access.

11. The device of claim 10, wherein the processor executes the instructions to:
compare the filtered information to the parameters and values of one or more criteria rules; and
determine whether the filtered event information matches the parameters and the values of at least one of the one or more criteria rules, and wherein when selecting the criteria rule, the processor further executes the instructions to:
select the criteria rule based on a match between the filtered event information and the parameters and the values of the criteria rule.

12. The device of claim 11, wherein the parameters include a parameter that indicates a particular product or service, a parameter that indicates a particular text string that is to be present in the event information, a parameter that indicates a reason for generating the ticket, and a parameter that indicates a last message sent to the customer regarding the ticket.

13. The device of claim 10, wherein each output result rule includes parameters and values for each parameter, wherein the parameters include a parameter that indicates whether to add a comment to the ticket, wherein the comment is not presented to the customer in the message, and a parameter that indicates whether to change an access to the message from the customer to internal personnel of the service provider.

14. The device of claim 13, wherein the processor to execute the instructions to:
determine whether the ticket correlates to a parent ticket, wherein the parent ticket pertains to an outage; and
obtain information pertaining to the parent ticket based on a determination that the ticket correlates to the parent ticket.

15. The device of claim 10, wherein the processor to execute the instructions to:
analyze the ticket information;
determine what action to take to resolve the ticket; and
transmit, via the communication interface, a request to the at least one of the device or the person to perform the action, based on a determination as to what action to take to resolve the ticket.

16. A non-transitory storage medium comprising instructions executable by a processor of a computational device, which when executed by the processor, cause the computational device to:
receive ticket information of a ticket that indicates a problem in providing a service, by a service provider, to a customer;
receive event information that indicates an action performed by at least one of a device or a person to resolve the ticket;
select a filter, among multiple filters, to filter the event information based on the action indicated in the event information;
select a criteria rule, from among multiple criteria rules, based on filtered event information and parameters included in the criteria rule, wherein each criteria rule includes parameters and values for each parameter;
select an output result rule, from among multiple output result rules, that maps to the criteria rule;
generate a message that provides an update to a status of the ticket based on the filtered event information and the output result rule; and
transmit the message to another device that the customer can access.

17. The non-transitory storage medium of claim 16, further comprising instructions, which when executed by the processor, cause the computational device to:
compare the filtered information to the parameters and values of one or more criteria rules; and
determine whether the filtered event information matches the parameters and the values of at least one of the one or more criteria rules, and wherein when selecting the criteria rule, the instructions further comprise instructions, which when executed by the processor, cause the computational device to:
select the criteria rule based on a match between the filtered event information and the parameters and the values of the criteria rule.

18. The non-transitory storage medium of claim 16, further comprising instructions, which when executed by the processor, cause the computational device to:
determine whether the ticket correlates to a parent ticket, wherein the parent ticket pertains to an outage; and
obtain information pertaining to the parent ticket based on a determination that the ticket correlates to the parent ticket.

19. The non-transitory storage medium of claim 16, further comprising instructions, which when executed by the processor, cause the computational device to:
analyze the ticket information;
determine what action to take to resolve the ticket; and
transmit a request to the at least one of the device or the person to perform the action, based on a determination as to what action to take to resolve the ticket.

20. The non-transitory storage medium of claim 16, wherein each output result rule includes parameters and values for each parameter, wherein the parameters include a parameter that indicates whether to add a comment to the ticket, wherein the comment is not presented to the customer in the message, and a parameter that indicates whether to change an access to the message from the customer to internal personnel of the service provider.
